(19) United States
(12) Patent Application Publication
(10) Pub. No.: US 2008/0197151 A1
(43) Pub. Date: Aug. 21, 2008

(54) HOPPER-TYPE TANK INCLUDING AT LEAST ONE ELEMENT PROJECTING FROM THE INSIDE PERIPHERY THEREOF

(75) Inventor: Roland Leblond, OCTEVILLE-SUR-MER (FR)

Correspondence Address: SUGHRUE MION, PLLC, 2100 PENNSYLVANIA AVENUE, N.W., SUITE 800, WASHINGTON, DC, 20037, US

(73) Assignee: SIDEL PARTICIPATIONS, OCTEVILLE-SUR-MER (FR)

(21) Appl. No.: 12/029,604

(22) Filed: Feb. 12, 2008

(30) Foreign Application Priority Data
Feb. 15, 2007 (FR) 07 01108

(51) Int. Cl. B65D 88/66; B67D 3/00

(52) U.S. Cl. 222/196; 222/564

(57) ABSTRACT

A hopper-type tank (1) for storing and dispensing solid bodies, the tank having a wall (3) on the inside face of which is fastened a plurality of obstacle members (4) situated in different planes and forming a mesh inside the tank (1), each obstacle member (4) having a substantially long and thin general main shape extending across the inner space of the tank, the obstacle member (4) extending between two locations of the inside face of the wall (3) of the tank (1); the tank has at least one first set of obstacle members (4) placed along a first direction in a first plane, and at least one second set of obstacle members (4) placed along a second direction, different from the first direction, in a second plane, thereby enabling the fall of solid bodies tipped in bulk into the top portion of the tank (1) to be slowed down.

### FIELD OF THE INVENTION

The present invention relates in general to the field of manufacturing containers (in particular bottles, flasks, or the like) out of thermoplastic material such as polyethylene terephthalate (PET) by blowing or stretch-blowing preforms, and more particularly it relates to improvements provided to the hopper-type tanks used for storing and dispensing preforms, which tanks are situated at the inlets of feeder devices of installations for manufacturing such containers. In still more specific manner, the invention relates to storing and dispensing tubular preforms, i.e. preforms that are generally cylindrical in shape and elongate, where the length of the body is generally greater than its diameter (e.g. three to four times greater).

### BACKGROUND OF THE INVENTION

Commonly, preforms are tipped in bulk into a hopper-type loading tank prior to being fed to installations for blowing preforms.

Nevertheless, when preforms are tipped into the tank, they run the risk of being damaged because of the impacts that can occur between two preforms or between a preform and the inside of the tank, which impacts can result in bruising, chipping, or cracking of the preform, thus leading to defective blown containers being made from such preforms.

In addition, such impacts can also lead to wear of the collars of preforms. Unfortunately, since it is common practice to transport preforms by means of their collars, any damage suffered by a collar runs the risk of causing the preform to be transported poorly, and can thus lead to the blowing installation becoming blocked.

In order to slow down the fall of preforms being tipped into the hopper-type tank, proposals have been made in the prior art to provide a succession of sloping planes inside the tank against which planes the preforms are tipped, with the preforms falling from one sloping plane to another. For example, one sloping plane might bear against one inside face of the tank, while another sloping plane bears against the opposite inside face of the tank.

Nevertheless, that solution is not satisfactory since the sloping planes take up a relatively large amount of room within the tank. As a result, the spaces for allowing preforms to pass from one sloping plane to another are small, unless the size of the tank is increased significantly, which is likewise not desirable. Furthermore, because of the narrowness of the spaces for passing preforms, numerous blocking points can arrive in the tank where the flow of preforms is likely to become blocked, whereupon the preforms cannot be recovered at the outlet in the bottom portion of the tank.

Furthermore, when storing preforms in a tank, the preforms situated at the bottom of the tank are loaded with a relatively large amount of weight as a result of the weight of all of the preforms overlying the preforms in the bottom portion.

In order to solve that problem, proposals have also been made to place sloping walls inside the tank, but that leads to the same problems as those mentioned above.

Because the preforms are made of plastics material, another problem with storing preforms arises from the fact that they become charged with static electricity because of friction between one another. The presence of this static electricity leads to dust becoming attracted onto the preforms where it sticks, and also to mutual attraction between preforms which stick to one another, thereby running the risk of forming bridges inside the tank and thus impeding removal of preforms from the tank.

In order to solve this problem of static electricity, proposals have been made to place air ionizers on the rails for feeding preforms to the blowing installation and situated at the outlet from the tank. Nevertheless, as well as being relatively expensive, that solution does not solve problems associated with the bridging effect occurring inside the hopper-type tank. In addition, dust is merely removed from preforms without being eliminated. The dust is therefore likely to become deposited on other preforms.

In order to solve more specifically the problem of bridges forming inside the tank, proposals have been made to place one or more vibrators against the wall of the tank. Nevertheless, that solution is not only ineffective, it also damages the tank.

### SUMMARY OF THE INVENTION

The present invention seeks to solve the problems associated with the prior art with the help of a tank serving to reduce the damage suffered by solid bodies on being tipped in bulk into the tank, to reduce the weight load carried by the solid bodies in the bottom portion of the tank, to reduce the static electric charge on solid bodies stored in the tank, and to reduce the risk of bridges forming inside the tank.

To this end, the present invention provides a hopper-type tank for storing and dispensing solid bodies, said tank having a wall on the inside face of which is fastened a plurality of obstacle members located in different planes forming a mesh inside the tank, each obstacle member having a substantially long and thin general main shape extending across the inner space of the tank between two locations of the inside face of the wall of the tank, the tank being characterized by having at least one first set of obstacle members placed along a first direction in a first plane, and at least one second set of obstacle members placed along a second direction, different from the first direction, in a second plane, thereby enabling the fall of solid bodies tipped in bulk into the top portion of the tank to be slowed down. This thus reduces the risk of damage to the solid bodies tipped into the top portion of the tank, and also slows down the fall of bodies tipped into the top portion of the tank.

Advantageously, the tank has a plurality of obstacle members located in mutually parallel planes.

In order to make it easier to clean the inside face of the wall of the tank, the obstacle member or at least one obstacle member is releasably fastened to the inside face of the wall of the tank.

In order to unblock solid bodies that have become blocked within the tank, e.g. due to the formation of a bridge, the obstacle member or at least one obstacle member is suitable for being set into vibration with the help of vibration means.

In order to reduce the static electricity charge on the hollow bodies, the obstacle member or at least one obstacle member is electrically conductive and is electrically connected to ground.

Advantageously, the obstacle member or at least one obstacle member is a tubular member, or a cord, or a chain, or a bar, or a cable, or a braided member.

### BRIEF DESCRIPTION OF THE DRAWING

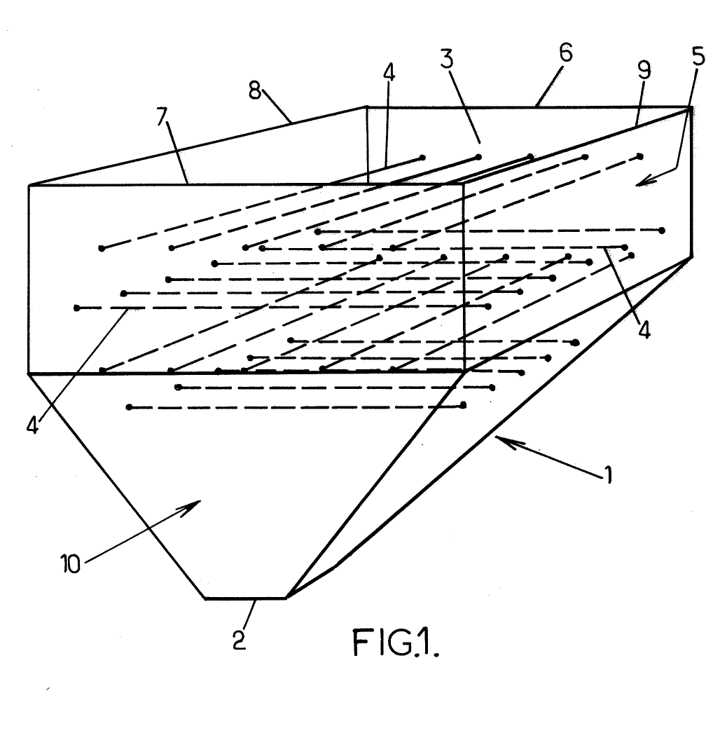

The present invention is described below with the help of an example that is purely illustrative and not limiting in any way on the scope of the invention, and with reference to accompanying FIG. 1 which is a diagrammatic perspective view of a hopper according to the invention.

### DETAILED DESCRIPTION OF THE INVENTION

FIG. 1 shows a tank 1 of the hopper-type for storing and dispensing solid bodies, and preferably preforms. Although the principle of the invention applies to any solid body suitable for being tipped in bulk into a tank via the top portion thereof so as to be subsequently stored therein and dispensed therefrom through a bottom opening 2 in the bottom portion of the tank 1, the invention is described more particularly for storing preforms, containers, hollow bodies, or bottles.

By definition, a hopper is a tank in the form of an upside-down truncated quadrangular pyramid. Even if the invention applies preferably to a hopper, the principle on which the invention is based applies to tanks of any shape, and not only to tanks having the shape of an upside-down truncated quadrangular pyramid, but also to tanks that are conical in shape or partially conical in shape.

The tank 1 has a wall 3 having fastened on an inside face thereof at least one obstacle member 4 having a substantially long and thin general main shape that extends across the inner space of the tank 1, thereby slowing down the fall of solid bodies tipped in bulk into the top portion of the tank 1.

Preferably, the obstacle member 4 extends between two locations of the inside face of the wall 3, even though it is also possible for the obstacle member 4 to bear against only one location of the inside face of the wall 3 of the tank 1, in which case the member 4 is cantilevered out.

The tank 1 preferably has a plurality of obstacle members 4 forming a mesh inside the tank 1, the mesh being of a size that is sufficient to allow the tipped in solid bodies to pass therethrough.

In order to make it easy to clean the inside face of the wall 3 of the tank 1, the obstacle member 4 is fastened releasably to the inside face of the wall 3 by any releasable fastener means of known type, e.g. using catch means or screw-fastener means.

Preferably, the tank 1 has a succession of obstacle members 4 located in different planes, and even more preferably a succession of obstacle members 4 situated in planes that are parallel to one another.

Thus, the tank 1 may present at least one first set of obstacle members 4 placed in a first direction in a first plane, and at least one second set of obstacle members 4 placed in a second direction, different from the first direction, in a second plane. In this way, the various obstacle members 4 are oriented in different directions and they are therefore not all parallel to one another. As a result, the vector direction defined by the obstacle members 4 of the first set is not parallel to the vector direction defined by the obstacle members 4 of the second set, said two vector directions then punctually crossing. It is thus possible to make a first set of obstacle members 4 that cross a second set of obstacle members 4.

Preferably, the first and second directions are substantially perpendicular relative to each other.

Thus, as shown in FIG. 1, the tank 1 has a main body 5 of quadrangle shape with two pairs of opposite walls 6-9 that are parallel in pairs; a first pair of parallel walls 6, 7 being interconnected by one plurality of obstacle members 4 that are substantially parallel to one another, while the second pair of parallel opposite walls 8, 9 is interconnected by a plurality of obstacle members 4 that are substantially parallel to one another.

The same can apply to the truncated square-based pyramid-shaped lower portion 10 of the tank 1, the opposite walls of which can be interconnected by a plurality of obstacle members 4.

The obstacle member 4 or at least one obstacle member 4 is suitable for being set into vibration with the help of vibration means. Preferably, the vibration means, which are of any known type, are provided being fastened either to the inside face of the wall 3 of the tank 1, or else to the outside face of the wall 3.

The obstacle member 4 or at least one obstacle member 4 is electrically conductive and is electrically connected to ground.

The obstacle member 4 or at least one obstacle member 4 is a tubular member, or a cord, or a chain, or a bar, or a cable, or a braided member.

In general, the obstacle members 4 are: either a) rigid members that are then cantilevered or else interconnect two locations of the inside face of the tank 1; or b) flexible members that therefore necessarily interconnect two locations of the inside face of the tank 1. Thus, the rigid obstacle members 4 are either bars or rods, being tubular or not, being hollow or not. The flexible obstacle members 4 are cords, cables, braids, etc.

Amongst the plurality of obstacle members 4 provided in the inner space of the tank 1, it is preferable to provide a combination of members 4, some being in the form of a chain, others of a cord, and others possibly being suitable for being set into vibration, and so on. The plurality of obstacle members 4 inside the inner space of the tank 1 need not necessarily all be identical and need not necessarily all present the same characteristics.

What is claimed is:

1. A hopper-type tank for storing and dispensing solid bodies, the tank having a wall on the inside face of which is fastened a plurality of obstacle members located in different planes forming a mesh inside the tank, each obstacle member having a substantially long and thin general main shape extending across the inner space of the tank, the obstacle member extending between two locations of the inside face of the wall of the tank, wherein at least one first set of obstacle members is provided being placed along a first direction in a first plane, and at least one second set of obstacle members is provided being placed along a second direction, different from the first direction, in a second plane, thereby enabling the fall of solid bodies tipped in bulk into the top portion of the tank to be slowed down.

2. A hopper-type tank according to claim 1, having a plurality of obstacle members situated in mutually parallel planes.

3. A hopper-type tank according to claim 1, wherein at least one obstacle member is releasably fastened to the inside face of the wall of the tank.

4. A hopper-type tank according to claim 1, wherein at least one obstacle member is suitable for being set into vibration with the help of vibration means.

5. A hopper-type tank according to claim 1, wherein at least one obstacle member is electrically conductive and is electrically connected to ground.

6. A hopper-type tank according to claim 1, wherein at least one obstacle member is a tubular member, or a cord, or a chain, or a bar, or a cable, or a braided member.
